(19) United States
(12) Patent Application Publication
(10) Pub. No.: US 2018/0249634 A1
(43) Pub. Date: Sep. 6, 2018

(54) PEANUT HARVESTER

(71) Applicants: Jason Morris, Tifton, GA (US); Matt Rewis, Tifton, GA (US); Raymond Way, Wray, GA (US); Bennie G Branch, JR., Tifton, GA (US)

(72) Inventors: Jason Morris, Tifton, GA (US); Matt Rewis, Tifton, GA (US); Raymond Way, Wray, GA (US); Bennie G Branch, JR., Tifton, GA (US)

(21) Appl. No.: 15/911,084

(22) Filed: Mar. 3, 2018

Related U.S. Application Data
(60) Provisional application No. 62/467,583, filed on Mar. 6, 2017.

(51) Int. Cl. A01F 11/00; A01F 12/50; A01F 12/22; A01F 12/10; A01F 12/44; A01F 12/00

(52) U.S. Cl. CPC A01F 11/00; A01F 12/50; A01F 12/00; A01F 12/10; A01F 12/444; A01F 12/22

(57) ABSTRACT

A harvester lifts plant material and usable product off the ground using a header to create one or more distinct ribbons of material which are each fed axially into the front of rotating foraminous drums carrying stripper springs and within which a rotor with threshing springs and a screw conveyor on its outer surface is cooperatively mounted. The usable product thus separated from the plant material exits the foraminous drums to be collected and conveyed to the cleaning portion of the harvester. The product and foreign material are mechanically sized using a series of rollers and an air stream separates the product for subsequent trimming of stems therefrom. The product is then deposited on a sizing conveyor further separation and weighing.

This application claims priority from U.S. Provisional Patent Application Ser. No. 62/467,583 filed on Mar. 6, 2017 which is incorporated herein for all purposes.

### FIELD OF INVENTION

The present invention relates to an axial flow harvester for peanuts.

### BACKGROUND

Peanut harvesting is a two stage process and the invention only applies to the second half, after the peanuts have been dug out of the ground, still attached to the vine, and positioned in windrows for the harvester. The peanut harvester picks the rows of vines and peanuts off the ground using a header, which also moves the vines and peanuts into the machine.

### SUMMARY OF THE INVENTION

This new style Peanut Harvester will allow farmers to harvest peanuts at higher ground speeds than current machines, with less damage to the peanut, and with less foreign material intermixed with the peanuts. The benefits for the farmer will be less time spent in the field harvesting, higher grade harvests and more money for the decrease in peanut damage, and less money spent removing foreign material (hay, rocks, dirt, leaves, etc.) from the peanuts.

The peanut harvester picks the rows of vines and peanuts off the ground using a header. The vines and peanuts are separated into two distinct ribbons of material which are each fed axially into the front of a pair of rotating drums. Inside and parallel to the rotating drum is a rotor, that is much smaller in diameter and has threshing springs and a screw conveyor on its outer surface. For a single rotor version, there would only be a single ribbon of material fed into a single rotating drum. Once inside the rotating drum, the peanuts are separated from the vines using the threshing springs while the vines are moved towards and discharged out of the rear of the rotating drum and harvester. Threshing is assisted by stripper springs located on the outer rotating drum that inter-mesh with the springs on the rotor. The peanuts, once separated from the vines, exit the rotating drum through holes in the periphery of the drum. The peanuts, as well as foreign material that also falls through the holes in the drum, are collected and conveyed to the cleaning portion of the harvester. Once in the cleaning section, the peanuts and foreign material are mechanically sized using a series of rollers where large debris is conveyed and discharged from the rear of the harvester, while the peanuts and other similarly sized material falls between the rollers and into an air stream. The air stream separates the peanuts from the unwanted material through weight and terminal velocity. Again the peanuts fall through the air stream while lighter material is conveyed and discharged from the rear of the harvester. The peanuts and small, heavy pieces of foreign material pass over a set of saws that trim the stem from the peanut shell. The peanuts are then deposited on a sizing conveyor, known as a cross conveyor, that allows objects smaller than desired to fall through the conveyor and onto the ground. The peanuts left on the cross conveyor are moved to a central location and finally conveyed into a holding tank.

### BRIEF DESCRIPTION OF THE DRAWINGS

Referring to the drawings which are appended hereto and which form a portion of this disclosure, it may be seen that:

FIG. 1 is a cut away view of an embodiment of the peanut harvester.;

FIG. 2 is a diagrammatic view of the flow of harvested material through the peanut harvester;

FIG. 3 is a diagrammatic view of the feed rollers of the peanut harvester;

FIG. 4 is a top plan view of the axial flow rotor;

FIG. 5 is an exploded perspective view of the axial flow screen;

FIG. 5a is a detail view from FIG. 5

FIG. 6 is a side schematic view of the axial flow screen;

FIG. 7 is a diagrammatic side view of the separator;

FIG. 8 is a diagrammatic view of the cross conveyor and load scale; and,

FIG. 9 is a diagrammatic view of the drive system.

### DETAILED DESCRIPTION

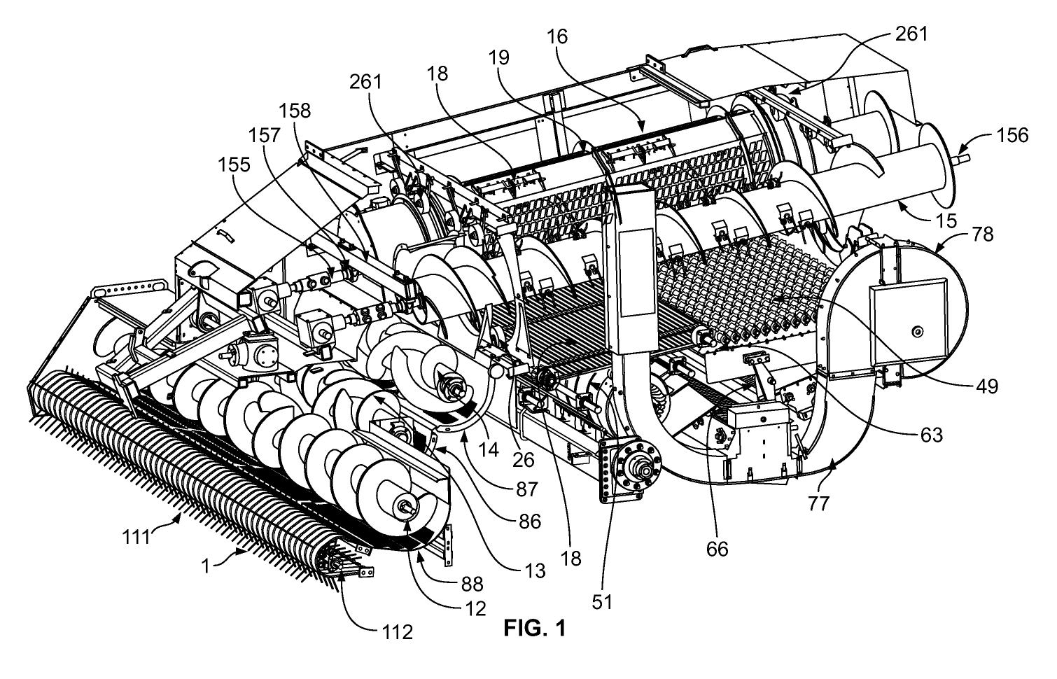

Referring to the figures which form a portion of this disclosure and which are incorporated herein, for a clearer understanding of the invention, it may be seen that FIG. 1 is a cut away view of the current embodiment of the peanut harvester. Prior to operating this harvester, the farmer would have used a peanut digger/inverter/windrower to dig the peanuts out of the ground and place them into windrows with two rows of peanut plants in each windrow. Twin row operations would have four rows in each windrow.

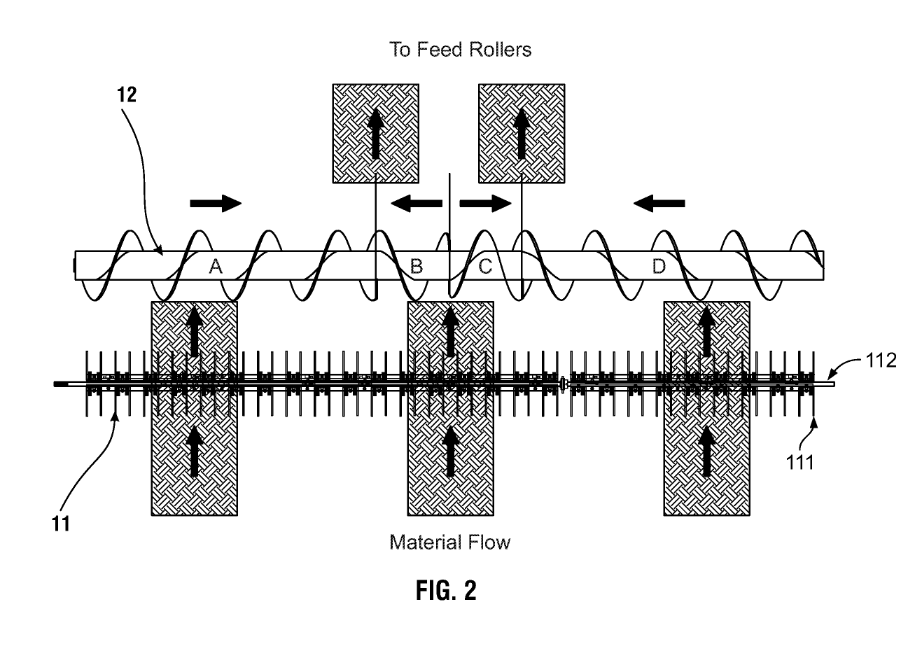

FIG. 1 depicts a six row head which is designed to harvest three windrows at a time. The head is comprised of a pick-up reel 11 and a header auger 12. The pickup reel 11 uses torsion springs 111 mounted to a rotating shaft 112 to lift the peanut windrows off the ground and feeds them into the front side of the header auger 12. As seen in FIG. 2, the header auger 12 is comprised of multiple screw conveyor sections A to D. Screw conveyor sections A and D urge the windrows on both sides of the center line rearward and towards the center of the Harvester. The center windrow is divided in half by screw conveyor sections B and C as the windrow material is urged laterally and rearward by the header auger 12. This is necessary because the harvester is designed to process two streams of material flow inside the machine.

In the illustrated embodiment, the pitch and diameter of the screw conveyor on the header auger 12 are equal with the intention that the material will be urged laterally at the same rate that it is urged rearward. This correlation provides maximum efficiency with the least amount of crop damage but is not an absolute requirement. As the material exits the rear of the header auger 12 it is fed into the lower feeder roller 13 and then into the upper feed roller 14. To efficiently move the material from one screw conveyor to the next, the distance between the periphery of one conveyor and the periphery of the adjacent conveyor should be less than 2.0 in but greater than 0.5 in. If the separation distance is larger than 2.0 in, rearward motion of the material will momentarily stall before continuing rearward, creating pulses of vine material that can damage peanuts and hamper the threshing process inside the threshing drum 16 As the material stalls between conveyors it builds in volume and may be carried back towards the front of the harvester, over the top of the previous screw conveyor before it has a chance to be moved by the adjacent conveyor as designed. Vine recirculation damages peanuts and encourages vines to wrap around the screw conveyors. Vines wrapping around a screw conveyor is a self-perpetuating process, meaning that once vines begin to wrap around the screw conveyor they continue to wrap and will often require the operator to stop harvesting and manually remove the wrapped vines. If the distance between the screw conveyor projections is less than 0.5 in, peanuts can become pinched between said projections causing unwanted damage.

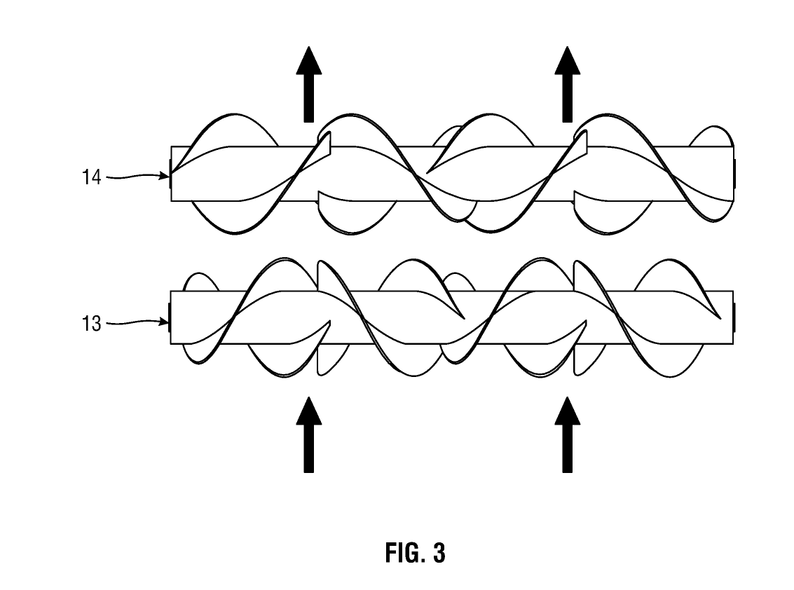

The feed rollers 13 and 14, seen in FIG. 3, also make use of screw conveyors to continue urging the material into two individual flows and to urge the material rearward and into the threshing rotor 15 and threshing drum 16. Both feed rollers make use of multiple section screw conveyors to continue dividing the center windrow and to align the two material flows for entry into the parallel threshing drums 16. The pitch of the screw conveyor on the lower feed roller 13 is approximately one and a half times larger than the diameter of the screw conveyor. A longer pitch screw conveyor urges the material flow more rearward that lateral. The pitch of the screw conveyor on the upper feed roller 14 is approximately two times larger than the diameter of the screw conveyor.

At this point the center windrow should be completely divided by the feed rollers and the material flows should be aligned with the entry points into the two threshing drums 16. It should be understood that hereinafter we will describe the structure of the threshing drum and rotor used to process one material flow with the understanding that the second material flow is processed by like structure. While the screw conveyor on the upper feed roller 14 urges the material mostly rearward, the arc of the screw conveyor impacting the material is much gentler than a straight paddle and is important in reducing damage to the peanuts in the material flow. Peanut damage is also affected by the rotational speed of both the upper and lower feed rollers 13 and 14. The ideal linear tip speed of the feed rollers is between 250 ft/min and 800 ft/min. Feed roller speeds below 250 ft/min will not remove material from the header auger 12 efficiently and will cause a backup in material flow. Feed roller speeds above 800 ft/min will accelerate the vine material disproportionately and damage peanuts. The process of moving the peanut vines from the pickup reel 11 into the threshing drum 16 is most efficient and causes the least peanut damage if the vine material stays intact and intertwined. All rotational speeds, clearances, and non-aggressive screw conveyors are designed with this goal in mind.

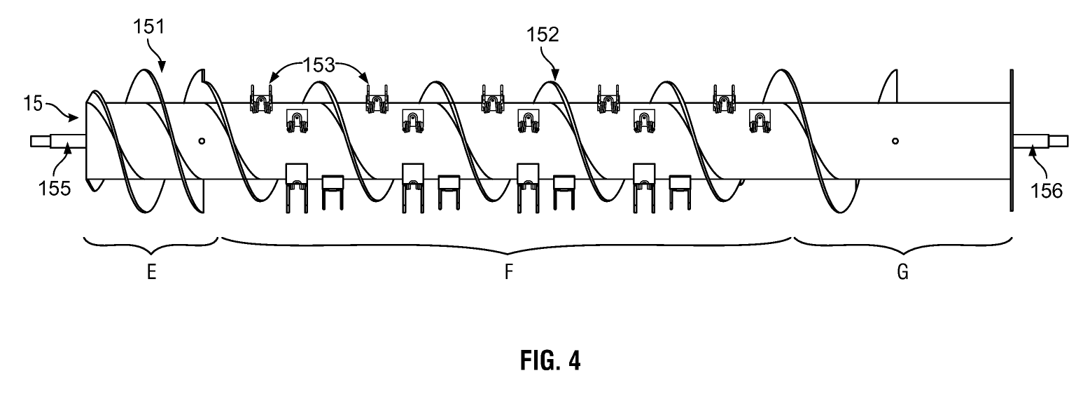

As the material exits the rear of the upper feed roller 14, it is moved into the threshing drum 16 by the screw conveyor fighting 151 on the front of the threshing rotor 15. The threshing rotor 15 can be divided into the three sections seen in FIG. 4. Section E is the entry section that urges the material into the threshing drum 16 using a screw conveyor with multiple leads for a smooth transition to axial flow. The leading edge of the screw conveyor fighting 151 has also been tapered to allow smooth engagement into the vine material and to decrease distance between the axis of the threshing rotor 15 and the screw conveyor on the upper feed roller 14 In addition, the speed of the threshing rotor 15 is set so that the lateral speed of the screw conveyor fighting on the front of the threshing rotor 15 is approximately equivalent to the linear tip speed of the fighting of upper feed roller 14 in an effort to continue the smooth transition into the threshing drum 16. It should be noted that the threshing rotor 15 is located inside the threshing drum 16 such that the axis of rotation of both the threshing rotor 15 and the threshing drum 16 are approximately parallel to each other and approximately parallel to the direction of travel.

The threshing drum 16 is mostly foraminous to allow peanuts removed from the vine to drop from the drum, but is substantially solid in the entry section to prevent material loss before it can be collected by the main conveyor 18 and to prevent material from moving forward in the direction of the upper feed roller 14. Section F of the threshing rotor 15 is comprised of a screw conveyor 152 to assist material in moving rearward through the machine and threshing springs 153 that aid in the removal of the peanuts from the vine mass. In this section, the maximum diameter of the screw conveyor fighting is significantly less than the tip diameter of the threshing springs 153 to allow penetration by the threshing springs 153 into the vine mass. Placement of the threshing springs 153 on the threshing rotor 15 is critical because the spring projections will interact with the spring projections of the stripper springs 162 that are located on the threshing drum 16 to create a shearing action on the material. If the alignment between the two sets of threshing springs is not correct, peanut damage can occur as the springs pass by each other too closely.

Section G of the threshing rotor 15 is the discharge portion of the rotor and uses a screw conveyor to move material out of the threshing drum 16 and into position for final processing via spreaders, gatherers, etc. Material in the discharge portion of the threshing rotor 15 should not include any marketable peanuts.

In the current embodiment, the maximum diameter of each section of the flights of the threshing rotor 15 of the center fighting is shorter to allow the threshing springs and stripper springs to inter mesh. The threshing rotor 15 has provisions to either be located concentrically or eccentrically inside the threshing drum 16. The threshing rotor 15 is supported axially by two bearings, one bearing 157 (shown in FIG. 1) depending from arm 158 engaging rotor shaft 155 near the front of the threshing rotor 15 proximal to where material enters the threshing drum 16 and one bearing, not shown, likewise supported and engaging rotor shaft 156 near the end of the threshing rotor proximate the material discharge from the machine. The location of the front bearing and the rear bearing perpendicular to the axis of rotation of the threshing rotor can be adjusted vertically, mostly normal to the ground, such that the axis of rotation of the threshing rotor 15 can either be concentric to the axis of the rotation of the threshing drum 16 or the axis of the threshing rotor 15 can be lower than the axis of rotation of the threshing drum 16 in one quarter inch increments up to one and one half inches of separation. The clearance between the threshing drum 16 and the threshing rotor 15 will be constant if the axes of rotation are concentric which will produce 360° of uniform threshing with can be important in material with high moisture content that is not sheared easily by the threshing springs. As the axes of rotation are separated, the clearance between the threshing drum 16 and the threshing rotor 15 is reduced during one half of the rotation and increased by an equal amount on the opposite half of rotation. This allows material, often with lower moisture content, to be compressed and sheared by the threshing springs in the area of reduced clearance. As the material moves to the area of increased clearance, the material has room to expand and allows the peanuts to separate from the vines and exit the threshing drum 16 through the openings in the threshing concaves 17. As a result, the radial clearances between the threshing rotor 15 and the threshing drum 16 can be changed to increase or decrease threshing as needed. The maximum diameter of each section of the threshing rotor 15, perpendicular to the rotation axis, could also be increased or decreased to increase or decrease threshing and increase or decrease material flow, or a combination thereof.

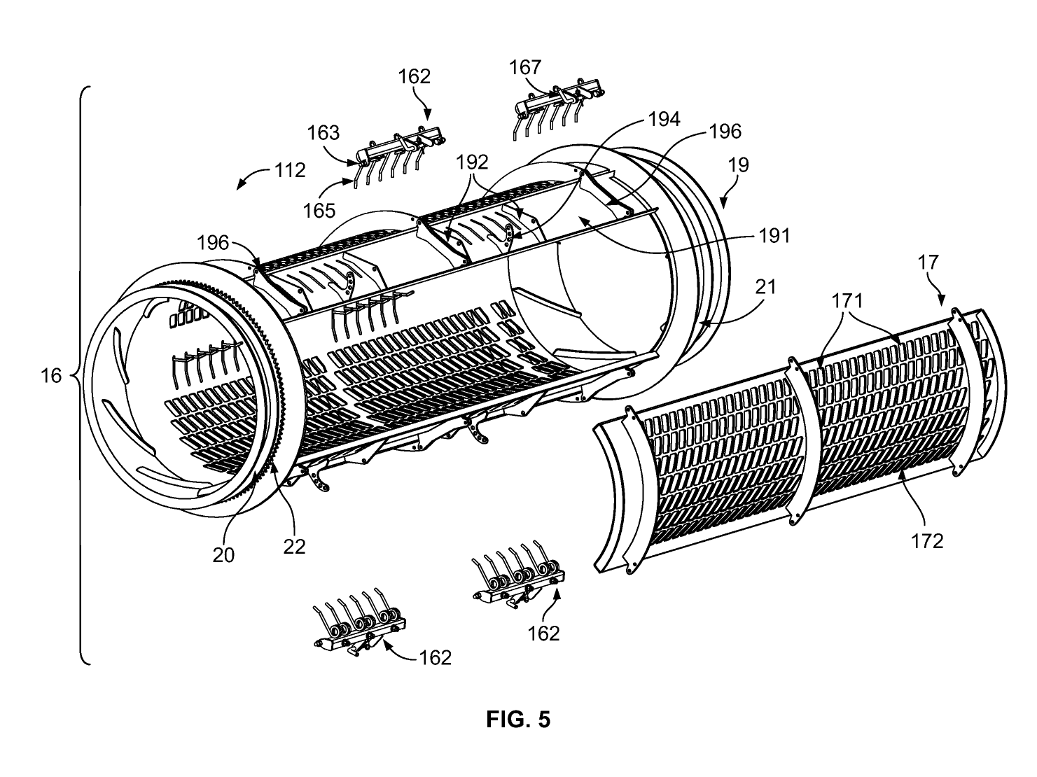

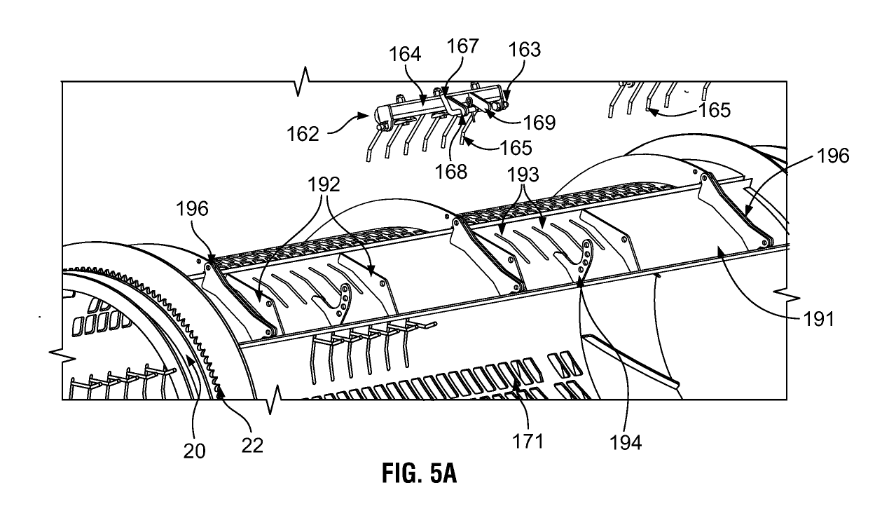

The threshing drum 16 consists of three main components, the threshing drum frame 19, the threshing concaves 17, and the stripper springs 162 as shown in FIGS. 5 and 5A. As previously mentioned, the stripper springs 162 are used in coordination with the threshing springs 153 on the threshing rotor 15 to create a shearing action in the material to remove peanuts from their vines.

The stripper springs 162 are located on the longitudinal sections 191 of the threshing drum frame 19. Affixed to longitudinal sections 191 are spring mounts 192 which engage stripper spring pins 163 carried by a stripper spring body 164 which also carries the stripper spring tines 165. Extending from stripper spring body 164 is a stripper spring clevis bracket 168 carrying a clevis pin 167. Also extending from stripper spring body 164 is an adjustment arm 169. The stripper spring tines 165 extend through slots 193 in the longitudinal sections 191 which are formed cooperatively between the spring mounts 192. Extending outwardly from the longitudinal sections 191, offset from the slots 193 and intermediate the spring mounts 192 is a curved tongue 194 having a plurality of apertures along its length positioned to receive clevis pin 167. The selection of the aperture in which clevis pin 167 is mounted to affix the stripper springs 162 determines the angle and depth of penetration of the stripper spring tines 165 into the threshing drum 16. Variability of the engagement of the stripper springs 162 is important because the threshing action needed to remove peanuts from their vines can vary based on peanut variety, peanut moisture content, vine moisture content, atmospheric conditions, soil composition, etc. Conditions are apt to change from one hour to the next and one field to the next. There are multiple groups of stripper springs 162 on each longitudinal section 191 of the threshing drum frame 19 so that stripper springs 162 can be mounted on the front, rear or middle, or any combination thereof, of the threshing drum 16 to obtain the desired threshing profile. Because the stripper springs 162 are mounted on the outside of the threshing drum 16 they are easily reached through access panels on the side of the harvester. This allows the harvester to be adjusted for conditions in a matter of minutes and is a major advantage over prior art harvester designs.

The threshing concaves 17 are attached to the threshing drum frame longitudinal sections 191 at mounts 196 with either pins or bolts, so that by removing the pins or bolts the threshing concave 17 will hinge open and allow access to the threshing rotor 15. Access to the threshing rotor 15 is important for threshing spring 153 replacement and other maintenance that might need to be performed inside the threshing drum 16. In the current embodiment there are three threshing concaves 17 and six sets of stripper springs 162 per threshing drum 16. The threshing concaves 17 give the drum its foraminous nature due to a number of openings 171 along the main curved portion 172 of the concave 17 to give the appearance of a sieve where peanuts are allowed to pass through the openings 171 in threshing concaves 17 and the remaining material is retained inside the threshing drum 16. The shape of the openings 171 in the threshing concaves 17 is trapezoidal with two sides parallel to the direction of material flow and the remaining two sides at an angle approximately 30° from perpendicular towards the rear of the drum 16. Since the threshing springs 153 on the threshing rotor 15 extend mostly radially, the angled sides of the openings 171 in the threshing concaves 17 tend to guide material pushed by the threshing springs against the threshing cylinder in a rearward direction. This aids the movement of material through the threshing drum 16 and increases throughput. Different shaped openings, other than the stated trapezoidal openings, can be used to sieve peanuts from the vine material, but there will be a loss of efficiency with such openings.

Since peanuts grow underground and are dug out of the ground, it is to be expected that there will be a lot of dirt mixed into the peanut vines. On prior art combines, this dirt and vine combination can bridge over the holes in the concaves in wet conditions and not let the peanuts fall through. When this occurs, the peanuts are swept out of the rear of the machine and onto the ground. A distinct feature of this peanut harvester is that the threshing drum 16 rotate, at a slow speed where centripetal forces are less than one gravitational constant, in an effort to keep the openings 171 in the threshing concaves 17 from bridging over with dirt. As a threshing concave 17 is carried to the upper position of the threshing drum's rotation, any material on the threshing concave 17 will be inverted where gravity will cause it to fall clear of the threshing concave 17. This process is repeated with each threshing concave 17 several times each minute so that the openings 171 in the threshing concaves 17 stay clear of obstructions and peanuts are allowed to fall through.

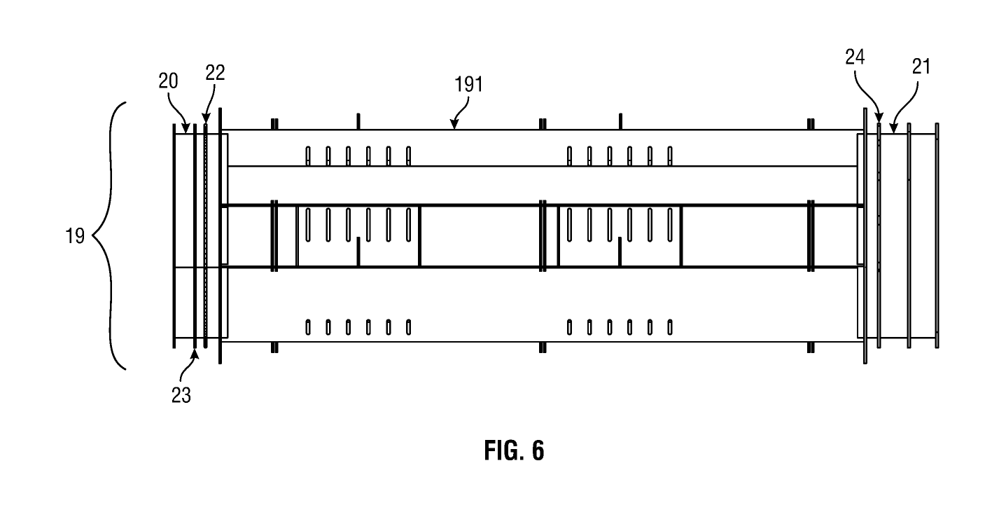

The threshing drum 16 is supported by two cylinder support rollers 26 at the front that ride in the front roller channel 20 and two cylinder support rollers 26 at the rear that ride in the rear roller channel 21. There are additional cylinder rollers 261 on the top side of the threshing drum 16 that control vertical movement. The cylinder support rollers 26 and 261 can be seen in FIG. 1 and FIG. 6 shows the corresponding roller channels 20 and 21 on the threshing drum frame 19. As the threshing rotor 15 pushes material through the threshing drum 16 there is a reactive reverse load that pushes the threshing drum 16 forward. This load is controlled by the thrust flange 23 on the threshing drum frame 19. The threshing drum 16 is chain driven using the cylinder drive sprocket 22. In case of a chain failure, an anti-rotation plate 24 and corresponding lockout have been added as a safety precaution to stop the threshing drum 16 from reversing and turning rapidly in the same direction as the threshing rotor 15.

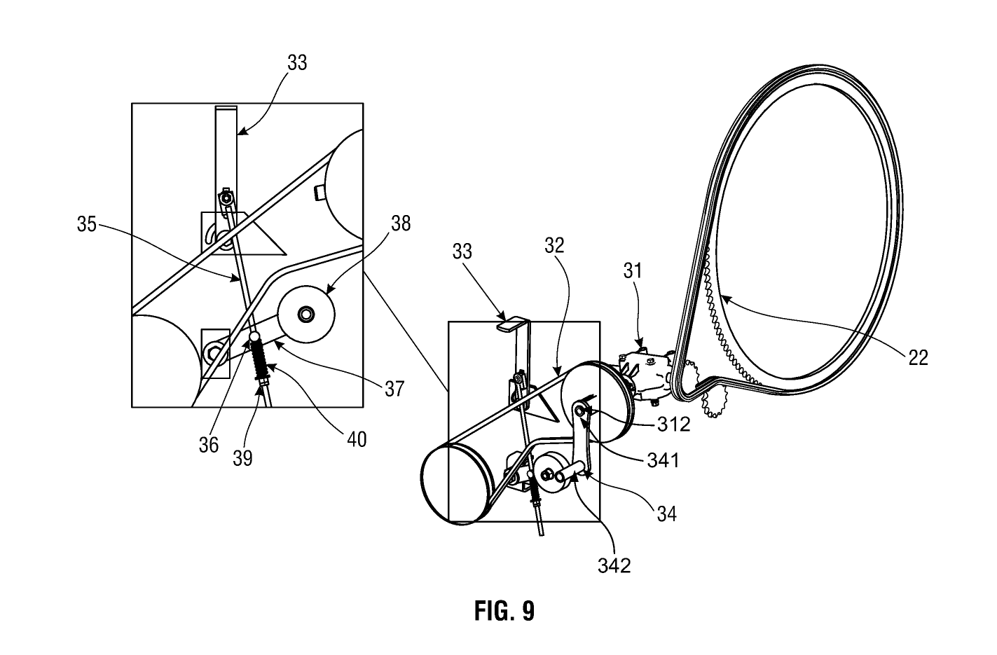

In the current embodiment shown in FIG. 9, the cylinder drive sprocket 22 is chain coupled to the cylinder drive box 31 attached to the harvester frame or chassis such that the axis of rotation of the input shaft of the cylinder drive box 31 is mostly perpendicular to the mostly vertical side of the harvester and the axis of rotation of the output shaft of the cylinder drive box 31 is parallel to the axis of rotation of the threshing drum 16. The input shaft of the cylinder drive box 31, or extension thereof, protrudes through the side of the harvester and is coupled to a powered shaft via the cylinder drive belt 32. The end of the input shaft farthest from the cylinder drive box 31 also has a hexagonal protrusion 312 for a manual input. Belt tension is supplied by the belt tension lock incorporating a rotatable handle 33 pivotally attached to a connecting rod 35 which is also pivotally attached to the idler swing arm 37 of an belt idler pulley 38 using a slip joint 36, after which the connecting rod 35 passes through a tension spring 40 and a spring retainer 39. As the belt tension lock handle 33 is rotated towards the mostly vertical operating position, the connecting rod 35 raises the belt idler pulley 38 until it engages the cylinder drive belt 32, at which point the connecting rod 35 slides through the slip joint 36 and the tension spring 40 is compressed between the slip joint 36 and the spring retainer 39. Belt tension is controlled by position of the spring retainer 39 on the connecting rod 35 which determines how far the tension spring 40 is compressed. An increase in tension spring compression increases belt tension and a decrease in tension spring compression causes a decrease in belt tension. As the belt tension lock handle 33 is rotated to the operating position, the connecting rod 35 passes the pivot location of the belt tension lock handle 33, at which point the belt tension lock handle 33 collides with a physical stop to prevent further rotation. This past center lock keeps tension on the belt during operation and quickly removes belt tension to manually turn the threshing drum 16.

Because the stripper springs 162 are located approximately every 120° around the exterior of the threshing drum 16, the threshing drum 16 must be rotated so each set of stripper springs 162 can be accessed for adjustment. Once the belt tension lock is disengaged, a manual turn handle 34, comprised of a rectangular plate with a hexagonal cutout 341 on one end and a round handle 342 welded to the opposite end, is used to engage hex protrusion 312 to manually rotate the input shaft of the cylinder drive box, which in turn rotates the threshing drum 16 so the stripper springs 162 can be accessed through removable panels on the side of the harvester. The hexagonal cutout 341 on the manual turn handle 34 slides over the hexagonal protrusion 312on the input shaft of the cylinder drive box 31 to enable the operator to apply force to the manual turn handle 34 to rotate the threshing drum 16. With the currently designed hexagonal engagement profile 312, the manual turn handle 34 must be removed during normal harvester operation, but with a simple change to the engagement profile or engagement mechanism, the manual turn handle 34 could remain on the input shaft of the cylinder drive box 31.

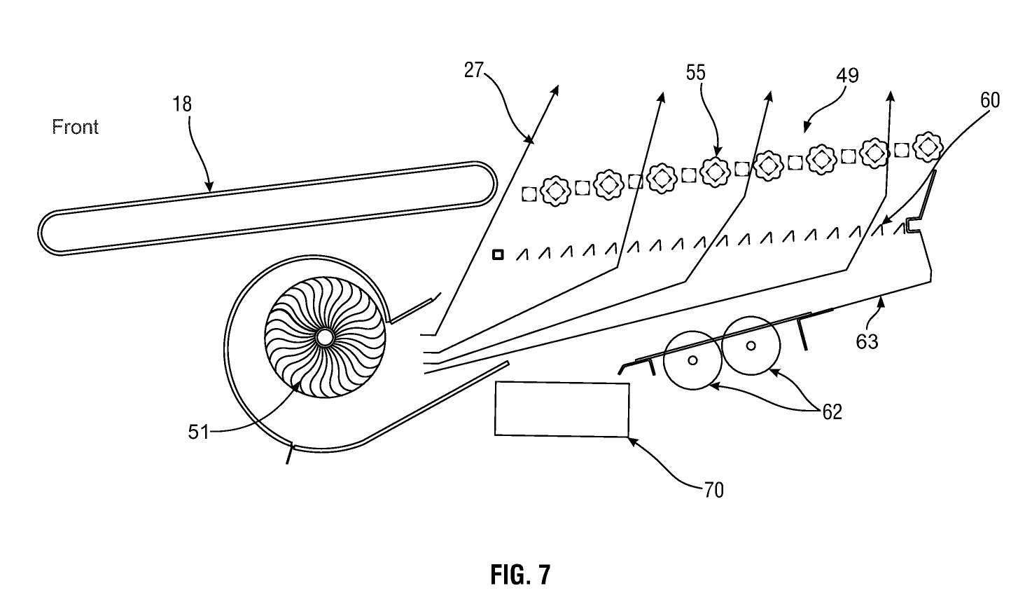

Below the threshing drums 16 are the main conveyor 18 and the mechanical sizing rollers 49 as seen in FIG. 7. Peanuts and foreign material that falls through the openings 171 in the front portion of the threshing concaves 17 fall onto the main conveyor 18 where they are moved to the mechanical sizing rollers 49. Conventional harvesters use a vibrating conveyor to convey peanuts and foreign material to the cleaning section of the harvester. Current vibrating conveyors in peanut harvesters typically have a low frequency, around 4 cycles per second, and as a result, they create pulses of material as they discharge material onto the cleaning area. The dwell time of the material on the vibrating conveyor before it is discharged can be high relative to a conventional conveyor belt, which allows the vertical height of material entering the conveyor to increase which magnifies the effects of each pulse on the cleaning section. Vibrating conveyors can also be difficult to balance and tend to have high maintenance requirements and part counts. In this embodiment, the main conveyor 18 is a continuous belt that discharges continuously at a high velocity to limit dwell time and therefore material height on the belt. Such a belt conveyor has a much lower part count and is virtually maintenance free for the life of the belt. The speed of the main conveyor 18 can also be changed to accommodate higher or lower volumes of material if necessary. The biggest advantage in the main conveyor 18 is the smooth discharge onto the mechanical sizing rollers 49. Most cleaning systems use air to separate the desired crop from foreign material and the pulses of material discharged by a vibratory conveyor momentarily overload the air cleaning system as each clump is discharged. The result is foreign material falls through the cleaning section of the harvester and ends up in the holding tank with the peanuts and if the clump is able to be moved across the separation air section, peanuts often don't have time to work down through the clump of vine material before being discharged from the harvester.

Finger like protrusions have been added to the rear of vibratory conveyors in an effort to reduce material density as it discharged from the vibratory conveyor, but the main conveyor 18 improves upon the standard vibrating conveyors without having to add additional parts. As the peanuts and foreign material pass over the rear of the conveyor belt they are lifted upward by an air blast 27 generated by the separation fan 51. The purpose of the air blast 27 is to create a vertical displacement of material where the heavier peanuts can fall down while lighter material such as leaves and small vines are held suspended. The peanuts and heavier material fall through the mechanical sizing rollers 49 and onto the air separation screen 60.

The mechanically driven sizing rollers 49 are comprised of a series of rotating bodies 52 with a substantially greater length than width or height, supported on generally horizontally disposed rods 53 where the rotation axis of each body 52 lies on a plane that is mostly parallel to the ground and the rotation axis is mostly perpendicular to the direction of material flow. The mechanical sizing rollers 49 are spaced such that the distance from the periphery of one roller to the periphery of the adjacent roller is large enough that only peanut sized objects, or smaller, can fall through to the air separation screens 60. In the current embodiment, the mechanical sizing roller bodies 52 have a square profile to increase motion of objects riding on the rollers. Typical rollers on other separators are round so material only interacts with a tangential point on the roller. With a square profile the material interact with a larger area of the roller and the angular position of the face of the roller changes as the roller rotates, so material is propelled with vertical and horizontal components. This can be important if a round object, like clod of dirt, were to end up on the rollers. Square profile rollers will discharge the clod from the harvester quickly, while round rollers would not be able to discharge the clod, or it may take a considerable amount of time. Additional roller profiles could include but be limited to additional polygonal shapes, splined profiles or a round profile that is not concentric with the rotation axis of the roller rods 53.

There are thin discs 55 mounted perpendicular and concentric to the axis of the rollers with a diameter larger than that of the rollers to align longer sections of vines perpendicular to the axis of the rollers. The distance from the circumference of the discs to the periphery of the adjacent roller is small enough that a peanut cannot enter there between and become damaged. Longer sections of vines, dirt clods, large rocks, etc., that don't fit between the rollers and are too heavy to be lifted into the air column are moved toward the rear of the machine and discharged by the mechanical sizing rollers 49. Peanuts and foreign material that fall through the rear portion of the threshing concaves 17 fall directly onto the mechanical sizing rollers 49. Air from the separator fan 51 passing through the mechanical sizing rollers 49 keep lighter foreign material suspended as the peanuts fall through to the air separation screens 60. Material suspended in the air over the mechanical sizing rollers 49 is also moved rearward and discharged from the rear of the harvester by the direction of the air discharged by the separator fans 51.

Below the mechanical sizing rollers 49 are the air separation screens 60. Air separation screens 60 consist of a mostly horizontal frame with a series of lateral slats that are connected to the frame on each end. The position and construction of the slats has been shown to alter the air flow uniformity and velocity coming through the air separation screen 60 and the mechanical sizing rollers 49, which is important for improving the overall separation efficiency. The slat spacing is also used as a secondary mechanical sizing operation to stop medium sized pieces of foreign material from continuing through the cleaning system. The air separation screens 60 use the air coming from the separator fans 51 to create the air velocity profile that peanuts and foreign material falling through the mechanical sizing rollers 49 encounter and are sized according to weight and terminal velocity. In the current embodiment, the air velocity is highest at the front of the screens where material from the main conveyor 18 is discharged and in generally reduced towards the rear of the harvester. Overall air velocity through the air separations screens can be adjusted by changing the speed of the separator fans 51 or other means. Peanuts of the same variety and moisture content have a similar terminal velocity, the speed of the separator fans 51 can be adjusted so that the air velocity on top of the air separation screens 60 is low enough for peanuts to fall through and anything with a lower terminal velocity will be blown out the back of the harvester. This often will include undesirable peanuts that have not fully matured and would lower the grade of the peanuts as a whole.

Below the air separations screens 60 are the stemmer saws 62. A stemmer saw 62is assembled by alternately stacking serrated discs and spacers on a shaft so that the discs are equally spaced and the leading edges of the serrations are pointed in the same direction. Two of these assemblies are mounted vertically below and independent from a catch pan so that the serrated disc protrudes through the top of the catch pan 63 as seen in FIG. 7. The two assemblies counter rotate and are used to remove the stem from the peanut hull.

Peanuts fall through the air separation screen 60 and onto catch pan 63 where they are conveyed through the stemmer saws by the motion of the catch pan. The catch pan 63 drops the peanuts and remaining foreign material on to a cross conveyor 70 that collects the peanuts across the width of the harvester and delivers them to one side for conveyance into the holding tank. The catch pan 63 is pivotally held at the front to one end of a lever 66 that is pivotally attached to the side of the machine frame at the opposite end, and the rear of the catch pan 63 is mounted to a bearing, not shown, that is eccentrically fixed to a shaft which in turn is fixed to the machine frame. As the shaft turns, the rear of the catch pan 63 moves in a circular motion with a diameter equal to the amount of eccentricity of the bearing mounted to the rear of the catch pan 63. As the rear of the catch pan 63 moves in a circular motion, the front of the catch pan 63 is allowed to oscillate in a mostly linear direction mostly parallel the ground. This motion is similar to the connecting rod in an engine with one end turned in circles by the crankshaft and pushing the piston linearly with the opposite end.

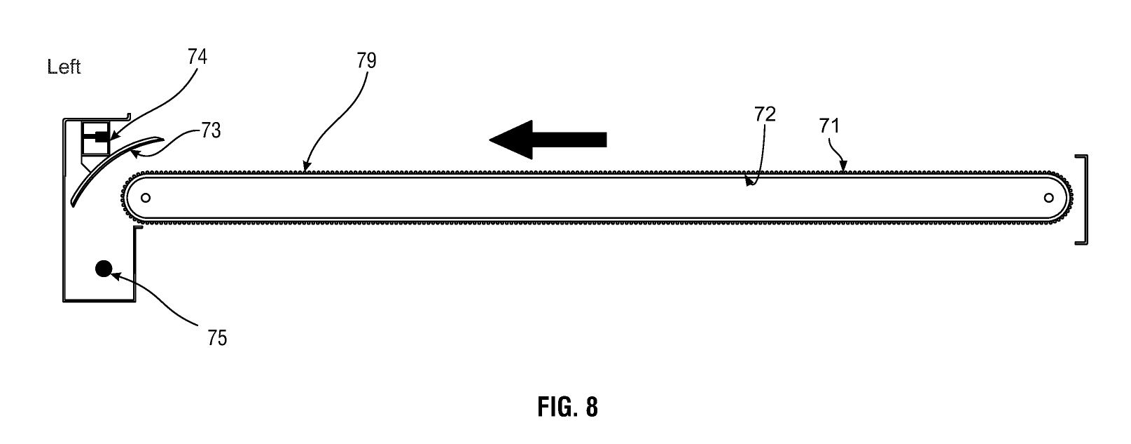

A cross section of the cross conveyor 70 is shown in FIG. 8. In the current embodiment, the cross conveyor 70 is comprised of solid rods 71, aligned perpendicular to the direction of belt travel, evenly spaced and fixed to a belt 72 on either end. The spacing between the rods is such that marketable peanuts, those still in the hulls, are suspended on the rods 71 of the conveyor while small foreign material falls between the rods and is deposited on the ground. As the peanuts traverse the width of the combine they are accelerated laterally until they are moving at essentially the same velocity as the cross conveyor 70.

As the peanuts are discharged from the end of the cross conveyor 70 they are directed into an impact plate 73 attached to an impact sensor 74. The impact plate 73 is curved so that the horizontal motion of the peanuts is redirected vertically down to the air lift conveyor 77. In the current embodiment the impact plate is the full length of the curvature needed to make the transition from horizontal to vertical, but future designs may utilize an impact plate with a shorter radial length in combination with a stationary concave plate that will continue the curvature need to make the horizontal to vertical transition in an effort to reduce cost and improve accuracy of the impact sensor 74. The impact sensor 74, impact plate 73 and air lift conveyor 77 are located in the conveyor drop box 75. As the peanuts collide with the impact plate 73 a portion of the kinetic energy of the peanuts is imparted to the impact plate 73 resulting in a deflection by the impact plate 73. The impact sensor 74 is attached to the impact plate 73 on one end and attached to the conveyor drop box 75 on the other end.

The deflection of the impact plate 73 is transferred to the impact sensor 74 where it is converted to an electronic signal. The electronic signal is sent to a control box, typically a logic circuit or micro-processor, along with the cross conveyor 70 radial velocity, measured by a tachometer, not shown, on the cross conveyor 70 drive shaft. The control box then uses an algorithm to convert radial velocity to linear velocity and through laws of energy conservation determines the weight of the peanuts required to cause the deflection measured by the impact sensor. Grain combines use similar technology to measure weight of grain harvester, but with a bucket elevator. When the contents of the bucket collide with the impact plate, the impact sensor measures the deflection and then returns towards a “zero” position before the next bucket of grain collides with the impact plate. This creates a series of pulses which is used to measure the weight of the grain harvested. On the peanut harvester, the cross conveyor 70 sends a continuous flow of peanuts into the impact plate 73 so it never has time to return towards a “zero” position and sensor instead returns a constant signal to the control box. Therefore, the impact plate deflection is recorded on set time intervals and the control box is calibrated to return the correct weight of the peanuts per time interval. The weight of the peanuts is compiled to display to the operator real time harvest yields and accumulated harvest weights. Real time harvest yields can warn the operator when something is wrong with the peanut harvester and when combined with GPS location data, yield maps can tell the farmer which areas of the field are more or less productive. Fertilizer prescriptions can be varied across the same field to improve crop yields for the next year. Accumulated weights also allow the operator to verify the weight of harvested peanuts sent to the peanut processors.

Once the peanuts are deposited in the air lift conveyor 77 an air flow provided by the air lift fan 78 conveys the peanuts into the holding tank where the harvest crop is gathered while in the field. Published US application 2016/0011024A1 discloses placing an impact plate and impact sensor in the duct work of an air lift conveyor. This is an undesirable location because the velocity of the peanuts as they travel through the air lift conveyor can change based on peanut density in the duct, variations in the air velocity created by the air lift fan, etc. and these changes can be difficult to measure accurately on a moving peanut harvester. Utilizing the cross conveyor 70, the peanut velocity is equivalent to the belt speed which is easily measured and varies very little as the harvester traverses a field. In addition, since the speed of the peanuts on the cross conveyor 70 is much lower than the speed of the peanuts in the air lift conveyor 77, impact of the peanuts on the impact plate is less likely to damage the peanut pods and is important in reducing loose peanut kernels.

The lower and upper feed pans 86 and 87 can be seen in FIG. 1 located below the lower and upper feed rollers 13 and 14. The feed pans support the peanut and vine material as the feed rollers urge the material laterally and rearward. The upper and lower feed pans 86 and 87, as well as the trough 88 below the header auger 12, are not solid, but rather have slots cut out of them to allow dirt from the peanut vines to exit the harvester and fall on the ground. The width of the slots is small enough so peanuts cannot fall through or become damaged when passing over them. The slots are also angled in the direction of the desired material flow. The angled slots help direct material in a small capacity, but also the angle keeps the slots from bridging over with dirt, keeping them open and continuing to allow dirt to exit the harvester.

When peanuts are dug out of the ground, large pieces of buried debris can become dislodged and is often fed into the peanut harvester by the pickup reel 11 and header auger 12. Large pieces of debris can become lodged between the feed rollers 13 and 14 and the feed pans 86 and 87. To assist in removal of the debris, the feed pans are attached to the peanut harvester with a rotating joint and a locating member to hold them in operating position. The leading end of feed pan 86, as defined by material flow, is pivotally attached to the machine frame at a flange under feed roller 13, with multiple concentric joints, forming a hinge. The trailing end of feed pan 86 has a locating hole in each side that corresponds to a mounting hole on each side frame of the combine. Feed pan 86 has to be rotated rearward and upward to pin it in its operating position. The trailing edge of feed pan 87 is pivotally attached to a mounting flange attached to the machine frame, under feed roller 14, with multiple concentric joints forming a hinge. The leading end of feed pan 87 has a locating hole in each side that corresponds to a mounting hole on each side frame. Feed pan 87 has to be rotated forward and upward to pin in its operating position. It should be noted that feed pan 86 has to be pinned in position before feed pan 87 can be pinned in position because the trailing edge of feed pan 86 rests on the top side of the leading edge of feed pan 87. The overlap allows for smooth material flow across the joint. Should something become lodged between the rollers and pans, the locating member can be removed and the pans will hinge downward and away from each other. This creates a large open area under the feed rollers 13 and 14 where an operator has access to the rollers and anything that may be lodged in the feeding area. Grain combines have similar arrangements that collect large rocks and keep them from entering the threshing portion of the harvester, but these are often narrow and don't provide easy access to the feeding portion of the harvester. Current peanut harvesters that use feed rollers don't have any provision for hinging the feed pans, and current conventional harvesters that don't use feed rollers and use laterally mounted threshing rollers and concaves, also don't offer features that would be equivalent to the hinging feeder pans.

Even though this disclosure specifically mentions peanuts as the crop being harvested, it should be noted that the process and equipment described herein can also be applied to edible beans, or other similar crops, similarly harvested in dried windrows where the crop pods are still attached to a vine or bush. While in the foregoing specification this invention has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

What we claim is:

1. A peanut harvester having one or more axial flow paths for peanut vines bearing peanuts including a path through at least one foraminous threshing drum having a plurality of stripping tines mounted thereon and mounted for driven rotation about a horizontal axis with a threshing rotor mounted within said at least one foraminous threshing drum for driven rotation in an opposite direction at a higher rate of speed and carrying a plurality of threshing tines extending in cooperative relationship with said plurality of stripping tines, a header for lifting and directing windrowed peanut vines to said one or more axial flow paths; at least one separator mechanism mounted below said at least one foraminous threshing drum for receiving peanuts stripped from said peanut vines and dropped thereunto.

2. A peanut harvester as defined in claim 1 wherein said foraminous threshing drum comprises:
a. a drum frame including annular end portions connected by a plurality of longitudinal sections, each longitudinal section including mounts for a plurality of stripper springs including tines selectively extending within said drum frame to pre-determined depths; and,
b. A plurality of foraminous concaves mounted intermediate said annular end portions and said plurality of longitudinal sections.

3. a peanut harvester as defined in claim 2 wherein said plurality of stripper springs are rotatably mounted externally of said longitudinal sections with said tines extending through apertures in said longitudinal sections such that rotation of said stripper springs to a selected position moves said tines to a selected extension within said drum.

4. A peanut harvester as defined in claim 2 wherein each of said foraminous concaves are mounted to said drum frame such that said foraminous concaves can be displaced to permit access to the interior of said at least one foraminous threshing drum.

5. A peanut harvester as defined in claim 1 wherein said harvester includes a chassis supporting said harvester and a housing surrounding said one or more threshing drums said housing including one or more movable panels that can be displaced to allow access to said threshing drums and said stripper tines.

6. A peanut harvester as defined in claim 1 further comprising a handle coupled to a drive for said at least one foraminous threshing drums to allow manual rotation to position said at least one foraminous threshing drum for selective adjustment of said stripper tines.

7. A peanut harvester as defined in claim 1 wherein said at least one threshing drum is mounted for rotation at a rotational speed wherein centripetal forces on said at least one threshing drum and any contents therein are less than one gravitational constant.

8. A peanut harvester as defined in claim 1 wherein said at least one separator mechanism for receiving peanuts stripped from said peanut vines and dropped thereunto comprises a plurality of driven rollers each roller of said plurality of rollers including a driven roller rod on which are mounted a plurality of roller bodies having a shape that is either polygonal, splined or eccentric with respect to said roller rod, with said shapes spaced apart to permit only peanut sized objects to pass therebetween as said plurality of driven rollers rotate.

9. A peanut harvester as defined in claim 8 further comprising a fan having an exhaust proximal said separator mechanism creating an air stream capable of removing material having a terminal velocity less than a peanut from said separator mechanism.

10. A peanut harvester as defined in claim 1 further comprising a harvest weight indicating system comprising a mechanical conveyor, driven at a known speed, having a discharge end and positioned to receive peanuts from said separator mechanism, an impact plate having a known curvature mounted proximate said discharge end such that peanuts discharged from said mechanical conveyor impact said plate causing a displacement of said plate, an electronic sensor operably connected to said impact plate to measure said displacement of said plate and having an output to a control box which converts said displacement of the plate of known curvature and the known mechanical conveyor velocity to produce a peanut mass flow rate.

11. A peanut harvester as defined in claim 10 wherein said mechanical conveyor is pervious to objects smaller than a desired peanut size such that additional separation of desirable peanuts is performed by said mechanical conveyor.

12. A peanut harvester as defined in claim 10 further comprising a GPS sensor capable of indicating data including the instantaneous position of said harvester for use in calculating and recording speed and area traversed by said harvest whereby the peanut mass flow rate can be combined with said data to provide an operator with real time crop yields and to create yield maps to determine farming prescriptions.

13. A peanut harvester having one or more flow paths for peanut vines bearing peanuts including a path through at least one threshing drum, a header for lifting and directing windrowed peanut vines to said one or more flow paths; at least one separator mechanism mounted below said at least one threshing drum for receiving peanuts stripped from said peanut vines and dropped thereunto.

14. A peanut harvester as defined in claim 13 wherein said at least one threshing drum comprises:
a. A drum frame including annular end portions connected by a plurality of longitudinal sections, each longitudinal section including mounts for a plurality of stripper springs including tines selectively extending within said drum frame to pre-determined depths; and,
b. a plurality of foraminous concaves mounted intermediate said annular end portions and said plurality of longitudinal sections.

15. A peanut harvester as defined in claim 14 wherein said plurality of stripper springs rotatably mounted externally of said longitudinal sections with said tines extending through apertures in said longitudinal sections such that rotation of said stripper springs to a selected position moves said tines to a selected extension within said drum.

16. A peanut harvester as defined in claim 14 wherein each of said foraminous concaves are mounted to said drum frame such that said foraminous concaves can be displaced to permit access to the interior of said at least one foraminous threshing drum.

17. A peanut harvester as defined in claim 14 wherein said harvester includes a chassis supporting said harvester and a housing surrounding said one or more threshing drums said housing including one or more movable panels that can be displaced to allow access to said threshing drums and said stripper springs.

18. A peanut harvester as defined in claim 13 further comprising a handle coupled to said at least one threshing drums to allow manual rotation of said at least one threshing drum to position said at least one threshing drum.

19. A peanut harvester as defined in claim 14 wherein said at least one threshing drum is mounted for rotation at a rotational speed wherein centripetal forces on said at least one threshing drum and any contents therein are less than one gravitational constant.

20. A peanut harvester as defined in claim 13 wherein said at least one separator mechanism for receiving peanuts stripped from said peanut vines and dropped thereunto comprises a plurality of driven rollers each roller of said plurality of rollers including a driven roller rod on which are mounted a plurality of roller bodies having a shape that is either polygonal, splined or eccentric with respect to said roller rod, with said shapes spaced apart to permit only peanut sized objects to pass therebetween as said plurality of driven rollers rotate.

21. A peanut harvester as defined in claim 20 further comprising a fan having an exhaust proximal said separator mechanism creating an air stream capable of removing material having a terminal velocity less than a peanut from said separator mechanism.

22. A peanut harvester as defined in claim 13 further comprising a harvest weight indicating system comprising a mechanical conveyor having a discharge end and positioned to receive peanuts from said separator mechanism and driven at a known speed, an impact plate having a known curvature mounted proximate said discharge end such that peanuts discharged from said mechanical conveyor impact said plate causing a displacement of said plate, an electronic sensor operably connected to said impact plate to measure said displacement of said plate.

23. A peanut harvester as defined in claim 22 further comprising an output to a control box which converts said displacement of the plate of known curvature and the known mechanical conveyor velocity to produce a peanut mass flow rate.

24. A peanut harvester as defined in claim 22 wherein said mechanical conveyor is pervious to objects smaller than a desired peanut size such that additional separation of desirable peanuts is performed by said mechanical conveyor.

25. A peanut harvester as defined in claim 22 further comprising a GPS sensor capable of indicating data including the instantaneous position of said harvester for use in calculating and recording speed and area traversed by said harvest whereby the peanut mass flow rate can be combined with said data to provide an operator with real time crop yields and to create yield maps to determine farming prescriptions.

26. A peanut harvester as defined in claim 13 further comprising a threshing rotor selectively mounted within said threshing drum at a distance between concentric rotation with said drum and non-concentric rotation with said threshing drum.

27. A peanut harvester as defined in claim 13 comprising one or more feed rollers mounted transversely across said harvester having fighting with a pitch between about 1.0 and 3.0 multiples of said fighting's diameter for the purpose of urging plant material into one or more ribbons feeding into said threshing drum.

28. A peanut harvester as defined in claim 27 wherein said feed rollers are mechanically driven to induce a linear speed an outer edge of said fighting of between about 250 ft/min and 800 ft/min to maintain a consistent ribbon of plant material.
